(19) United States
(12) Patent Application Publication
(10) Pub. No.: US 2023/0003960 A1
(43) Pub. Date: Jan. 5, 2023

(54) OPTICAL FIBER CABLE INCLUDING SUPERABSORBENT POWDER CONTAINING HIGH CONCENTRATION OF FLOW AID AND METHOD OF MANUFACTURING SAME

(71) Applicant: CORNING RESEARCH & DEVELOPMENT CORPORATION, Corning, NY (US)

(72) Inventors: Anne Germaine Bringuier, Taylorsville, NC (US); Leigh Rooker Josey, Hickory, NC (US); Joel Laine Parker, Hickory, NC (US)

(21) Appl. No.: 17/892,278

(22) Filed: Aug. 22, 2022

Related U.S. Application Data
(63) Continuation of application No. PCT/US2021/018307, filed on Feb. 17, 2021.
(60) Provisional application No. 62/984,874, filed on Mar. 4, 2020.

(51) Int. Cl. G02B 6/44

(52) U.S. Cl. CPC G02B 6/4494; G02B 6/4433; G02B 6/4434

(57) ABSTRACT

Embodiments of an optical fiber cable are provided. The optical fiber cable includes a cable jacket and a plurality of buffer tubes contained within the cable jacket. Each of the plurality of buffer tubes has one or more optical fibers disposed therein. A thin film tube is contained within the cable jacket and disposed around the buffer tubes, and an armor layer is contained within the cable jacket and disposed around the thin film tube. Superabsorbent polymer (SAP) powder is disposed between the thin film tube and the armor layer. The SAP powder includes at least 1 wt % of silica particles.

### PRIORITY APPLICATION

This application is a continuation of International Patent Application No. PCT/US2021/018307 filed. Feb. 17, 2021, which claims the benefit of priority of U.S. Provisional Application No. 62/984,874, filed on Mar. 4, 2020, the content of which is relied upon and incorporated herein by reference in its entirety.

### BACKGROUND

The disclosure relates generally to an optical fiber cable and in particular to an optical fiber cable having a superabsorbent polymer powder containing a high concentration of a flow aid applied between components of the optical fiber cable. Optical fiber cables have various constructions depending on their use and environment in which they are located. The constructions include various layers or components in which each layer or component is present for a particular function or purpose in the overall cable design. However, optimization of one layer or component may create processing or operating issues with another layer or component. In this regard, tradeoffs in optimal function may be made, taking into account economic and practical realities of the cable design and manufacture.

### SUMMARY

According to an aspect, embodiments of the disclosure relate to an optical fiber cable. The optical fiber cable includes a cable jacket and a plurality of buffer tubes contained within the cable jacket. Each of the plurality of buffer tubes has one or more optical fibers disposed therein. A thin film tube is contained within the cable jacket and disposed around the buffer tubes, and an armor layer is contained within the cable jacket and disposed around the thin film tube. Superabsorbent polymer (SAP) powder is disposed between the thin film tube and the armor layer. The SAP powder includes at least 1 percent by weight (wt %) of silica particles.

According to another aspect, embodiments of the disclosure relate to a method of manufacturing an optical fiber cable. In the method, a superabsorbent polymer (SAP) powder is applied between a cable core and an armor layer. The cable core includes a plurality of buffer tubes surrounded by a thin film tube. Each of the plurality of buffer tubes contains one or more optical fibers. The SAP powder is applied between an exterior surface of the thin film tube and an interior surface of the armor layer. The SAP powder includes at least 1 wt % of silica particles.

According to still another aspect, embodiments of the disclosure relate to an optical fiber cable. The optical fiber cable includes a first cable component, a second cable component, and superabsorbent polymer (SAP) powder. The SAP powder includes at least 1 wt % of silica particles. The SAP powder is disposed between the first cable component and the second cable component, and the SAP powder inhibits or prevents bonding between the first cable component and the second cable component.

Additional features and advantages will be set forth in the detailed description that follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments. In the drawings:

FIG. 1 depicts an optical fiber cable, according to an exemplary embodiment.

FIG. 2 depicts a method of preparing an optical fiber cable, according to an exemplary embodiment.

FIG. 3 depicts a powder applicator for applying superabsorbent polymer powder between the thin film tube and the armor layer, according to an exemplary embodiment.

### DETAILED DESCRIPTION

Referring generally to the figures, various embodiments of an optical fiber cable and method of manufacturing same are provided. The optical fiber cable includes superabsorbent polymer (SAP) powder that contains a relatively high concentration of a silica-based flow aid disposed between two components of the optical fiber cable. For the purposes of discussion, the SAP powder will be described in relation to an optical fiber cable containing a thin film tube and an armor layer. The thin film tube surrounds a plurality of buffer tubes containing optical fibers, and the armor layer surrounds the thin film tube. In this exemplary embodiment of a cable construction, the SAP powder containing the high concentration of silica-based flow aid is disposed between the thin film tube and the armor layer to not only provide water-blocking protection for the optical fiber cable but also to prevent bonding between the armor layer and the thin film tube. In this context, using the SAP powder containing the high concentration of flow aid to overcome the issue of partially bonding between the armor layer and the thin film tube allows for use of the thin film tube in the optical fiber cable construction. The thin film tube provides easy access for a customer as it eliminates the need to cut through counter helically wrapped polyester yarns conventionally used around buffer tubes, and it provides several cost and processing advantages over conventional binder wraps. These and other aspects and advantages will be discussed more fully below and in relation to the drawing. The embodiments presented herein are provided by way of example and not by way of limitation.

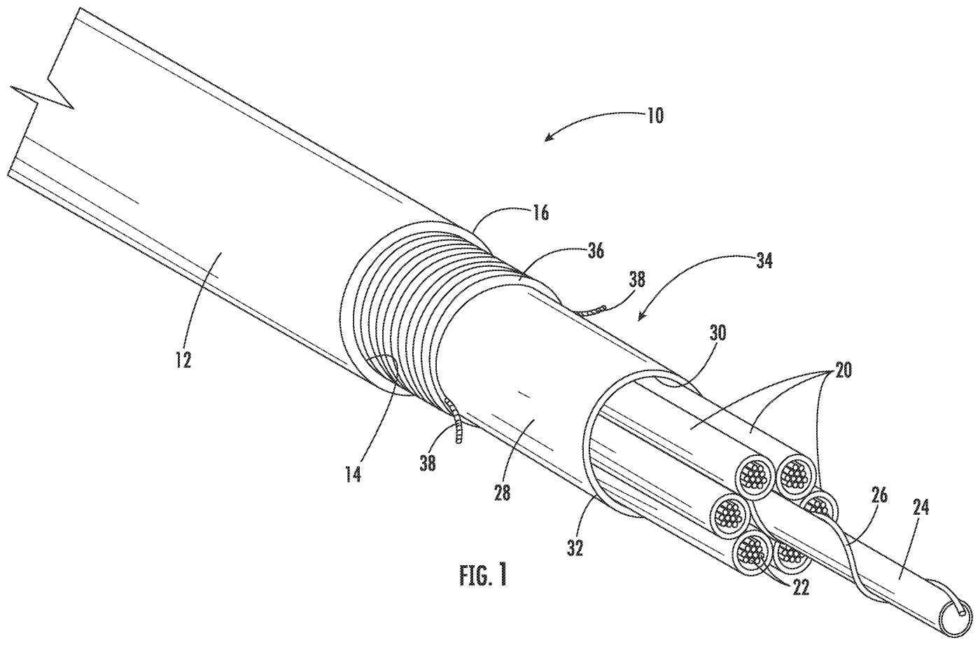

FIG. 1 depicts an embodiment of an optical fiber cable 10. The embodiment of the optical fiber cable 10 presented herein is for the purpose of illustration only, and the disclosure pertaining to the SAP powder containing the silica-based flow aid is application to other optical fiber cable constructions. With respect to the embodiment presented herein, the optical fiber cable 10 includes a cable jacket 12. The cable jacket 12 has an inner surface 14 and an outer surface 16. In embodiments, the outer surface 16 of the cable jacket 12 is the outermost surface of the optical fiber cable 10. Disposed within the cable jacket 12 are a plurality of buffer tubes 20. Each buffer tube 20 includes one or more optical fibers 22. In the embodiment depicted, the optical fibers 22 are arranged in the buffer tubes 20 in a loose tube configuration. Further, the optical fibers 22 are individual optical fibers 22, but in other embodiments, the optical fibers 22 could be arranged, e.g., in one or more ribbons. In embodiments, the buffer tubes 20 run along or are stranded around a central strength member 24. In embodiments, a water-blocking yarn 26 is wrapped around the central strength member 24.

In the embodiment depicted, the buffer tubes 20 are surrounded by a thin film tube 28. The thin film tube 28 has an interior surface 30 and an exterior surface 32 defining an average thickness therebetween of from 0.08 mm to 0.30 mm, more particularly 0.10 mm to 0.20 mm. In embodiments, the thin film tube 28 is made of a polyolefin, such as linear low density polyethylene (LLDPE), polypropylene impact copolymer, or a flexible polyvinyl chloride (PVC), among others. As used herein, the thin film tube 28 and the cable components contained therein may be referred to as a cable core 34. In this regard, the exterior surface 32 of the thin film tube 28 may be the outermost surface of the cable core 34.

SAP powder is contained within the thin film tube 28 around the buffer tubes 20 to provide a measure of water blocking on the interior of the cable core 34. Conventional cable designs typically use water-blocking tapes and yarns wrapped around the buffer tubes 20. However, the thin film tube 28 of the presently disclosed optical fiber cable 10 is less expensive in terms of material cost than water-blocking tapes and yarns, and the thin film tube 28 is easier to apply by extruding around the buffer tubes and is not length limited. That is, the thin film tube 28 can be extruded continuously without stopping, whereas water blocking tapes and yarns are wound around the buffer tubes from spools that have to be changed as they run out, which creates disruptions during processing.

Provided around the cable core 34 in the embodiment depicted is an armor layer 36. The armor layer 36 circumferentially surrounds the cable core 34 along the length of the optical fiber cable 10 so as to protect the cable core 34, e.g., from damage by rodents. In embodiments, the armor layer 36 is formed from a metal tape that is wrapped around the cable core 34, which may provide a region where edges of the metal tape overlap to close the armor layer 36. In embodiments, the armor layer 36 is corrugated. Further, in embodiments, the armor layer 36 is laminated with a coating (e.g., of polyethylene or a polyethylene copolymer) to prevent rusting of the armor layer 36. As will be discussed more fully below, SAP powder containing a relatively high amount of a flow aid is provided between the exterior surface 32 of the thin film tube 28 and the armor layer 36. The SAP powder containing the flow aid not only provides water blocking along the exterior length of the cable core 34, but the SAP powder containing the flow aid also inhibits or prevents bonding between the armor layer 36 and the exterior surface 32 of the thin film tube 28.

In the embodiment depicted, the cable jacket 12 circumferentially surrounds the armor layer 36 along the length of the optical fiber cable 10. In embodiments and as discussed below, the cable jacket 12 is extruded around the armor layer 36 such that the inner surface 14 of the cable jacket 12 contacts the exterior of the armor layer 36. In embodiments, the optical fiber cable 10 includes an access feature shown as ripcords 38. The ripcords 38, which may be made from aramid yarn, can be pulled to split open the armor layer 36 to provide access to the cable core 34 to allow for mid-span access to the buffer tubes 20 or the optical fibers 22 contained therein. In other embodiments, the cable jacket 12 may be coextruded with a strip of dissimilar polymer (e.g., one or more polypropylene strips in a polyethylene jacket) to provide a fast access feature so that the cable jacket 12 can be split open with a side cutter and pulled apart by hand. Additionally, in embodiments, an access feature, such as a ripcord (not shown), may be provided within the thin film tube 28 to provide access to the interior of the thin film tube 28.

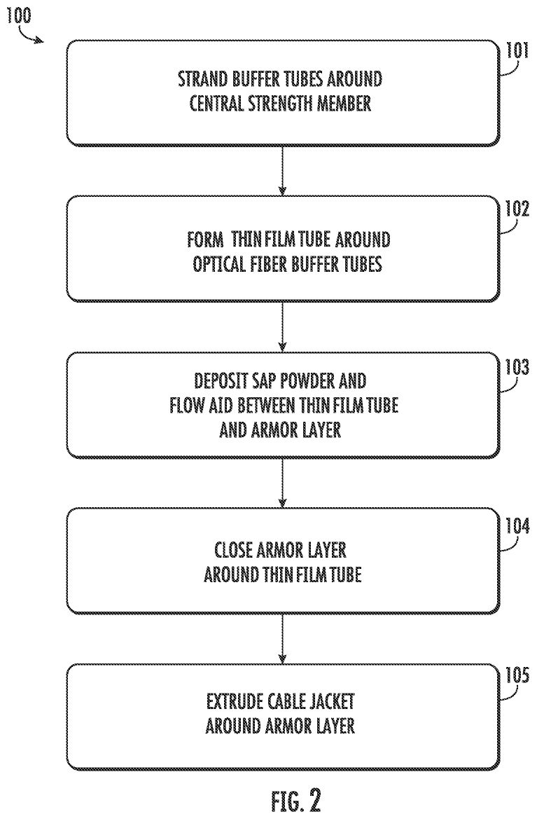

FIG. 2 provides a flow diagram for a method 100 of manufacturing an optical fiber cable, such as the optical fiber cable 10 as shown in FIG. 1. For context, in the discussion of the method 100 of FIG. 2, reference will be made to the components of the optical fiber cable 10 shown in FIG. 1. In a first step 101 of the method 100, buffer tubes 20 are stranded around the central strength member 24. In a second step 102, the thin film tube 28 is formed around the buffer tubes 20, e.g., by extruding the thin film tube 28 around the buffer tubes 20. As mentioned above, extruding the thin film tube 28 around the buffer tubes 20 allows for continuous operation without having to stop to change spools as has been the case when using water blocking tapes and/or yarns around the buffer tubes.

In a third step 103, SAP powder containing a flow aid is applied between the thin film tube 28 and the armor layer 36. In embodiments, the SAP powder is a potassium acrylate acrylamide copolymer. In embodiments, the average particle size of the SAP powder ranges from 0 to 230 μm. Further, in embodiments, the SAP powder contains a relatively high concentration of a flow aid compared to a typical SAP powder. Conventionally, an SAP powder contains less than 1 wt % of a flow aid, in particular about 0.3 wt % to 0.5 wt % of a flow aid. However, according to the present disclosure, the SAP powder contains at least 1 wt % of a flow aid. In an embodiment, the SAP powder contains from 1 wt % to 5 wt % of the flow aid, in particular about 2 wt % (e.g., from 1.5 wt % to 2.5 wt %) of the flow aid. In embodiments, the flow aid is a silica-based flow aid. Specifically, in embodiments, the silica-based flow aid has a platelet structure designed to surround the SAP powder particles to enhance the flow characteristics. In embodiments, the silica-based flow aid comprises silica particles. In a specific embodiment, the silica particles are fumed silica particles having an average particle size 100 nm or less, in particular, from 5 nm to 50 nm. Further, in embodiments, the silica-based flow aid is hydrophobic, which provides processing advantages in that it does not tend to clog application equipment. An example of hydrophobic silica is fumed silica treated with dimethyldichlorosilane (such as AEROSIL® R972, available from Evonik Resource Efficiency GmbH, Hanau-Wolfgang, Germany).

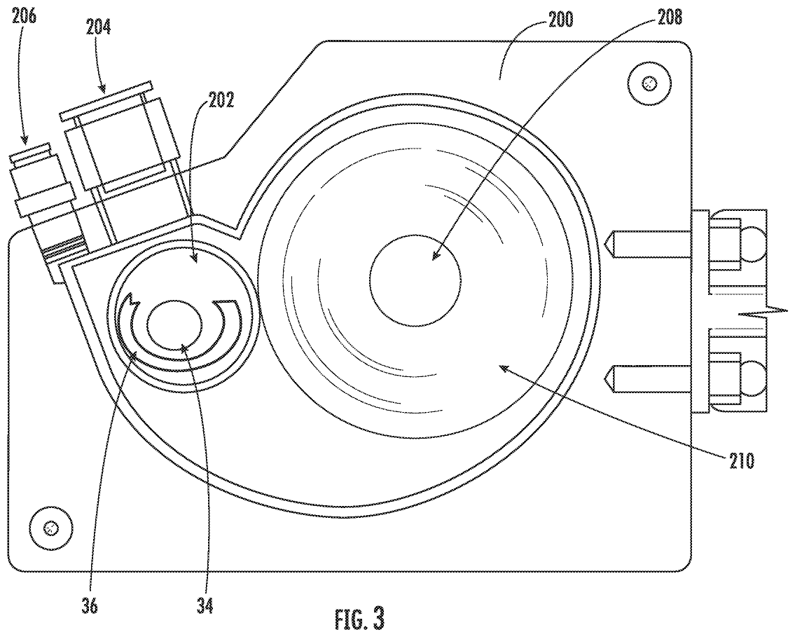

FIG. 3 depicts an embodiment of a powder applicator 200 usable for applying the SAP powder containing the flow aid to the cable core 34. The powder applicator 200 includes a process line inlet 202 through which the cable core 34 and partially formed armor layer 36 run. As can be seen in FIG. 3, the armor layer 36 is partially formed to create a trough under the cable core 34. The powder applicator 200 includes an SAP powder inlet port 204 through which the SAP powder containing the flow aid is injected into the powder applicator 200. The SAP powder inlet port 204 allows for direct application of the SAP powder and flow aid to the cable core 34 and interior surface of the armor layer 36. In this way, when the armor layer 36 is fully formed around the cable core 34, the SAP powder and flow aid completely surround the circumference of the cable core 34. The powder applicator 200 also includes a pressured gas inlet 206. In embodiments, the pressurized gas inlet 206 disperses the SAP powder to prevent clumping and to better and more uniformly coat the cable core 34. The pressurized gas may be, e.g., compressed air, N₂, CO₂, Ar, or another substantially inert gas.

The powder applicator 200 also includes an exhaust port 208 surrounded by a Venturi region 210. The SAP powder containing the flow aid that does not coat the cable core 34 or the armor layer 36 is circulated in the Venturi region 210 by the pressured gas, and the centrifugal force causes the SAP powder containing the flow aid to circulate back to the cable core 34 and armor layer 36 where it can be applied or recirculated by the pressurized gas. The pressurized gas exits via the exhaust port 208. Additional description of embodiments of the powder applicator 200 may be found in U.S. Pat. No. 10,427,177, issued on Oct. 1, 2019, and owned by the common assignee to the present application. U.S. Pat. No. 10,427,177 is incorporated herein in its entirety by reference thereto.

After the SAP powder containing the flow aid is applied to the cable core 34 and armor layer 36, the method 100 involves a fourth step 104 of closing the armor layer 36 around the cable core 34. Thereafter, in a fifth step 105, the cable jacket 12 is extruded around the armor layer. In embodiments, between the fourth step 104 and the fifth step 105, the cable core 34 having the armor layer 36 closed around it may pass through another powder applicator in which talc is applied to the outer surface of the armor layer 36 to prevent sticking between the armor layer 36 and the cable jacket 12.

During extruding in the fifth step 105, the extruded polymer of the cable jacket 12 may be at a temperature of from 180° C. to 230° C., and because of the high temperature, the polymer material of the cable jacket 12 transfers heat through the armor layer 36 to the thin film tube 28. Previously, the heat could in certain circumstances cause the thin film tube 28 to partially bond to the armor layer 36, especially between the polymer coating of a laminated armor layer 36 and the thin film tube 28. However, according to the present disclosure, the use of an SAP containing a high concentration (1 wt % to 5 wt %) of the silica-based flow aid inhibits or prevents the partial bonding between the thin film tube 28 and the armor layer 36.

Thus, according to the present disclosure, the optical fiber cable 10 is able to take advantage of the longer, uninterrupted processing runs associated with the use of the thin film tube 28 without also experiencing the issue of partial bonding between the coating of the armor layer 36 and the thin film tube 28. The prevention of such partial bonding is associated with the use of the SAP powder containing the relatively high concentration of the silica-based flow aid.

While the present disclosure has been framed in terms of preventing partial bonding between a thin film tube 28 and an armor layer 26, the SAP powder comprising the high concentration of silica-based flow aid can be used to prevent bonding between other cable components in an optical fiber cable 10. Such cable components may include the optical fibers 22, the buffer tubes 20, the thin film tube 28, the armor layer 36, and/or the cable jacket 12, among other cable components known in the art as they relate to other cable constructions. For example, the SAP powder may be used to prevent bonding between the thin film tube 28 and the cable jacket 12 (i.e., without an armor layer 36 being present therebetween). Additionally, in embodiments, the SAP powder may be used to prevent bonding between the buffer tubes 20 and the thin film tube 28 or between the buffer tubes 20 and the cable jacket 12 (i.e., without a thin film tube 28 or armor layer 26 being present therebetween). Still further, in other embodiments, the SAP powder may be used to prevent bonding between the optical fibers 22 and the buffer tubes 20 during the buffer process. In general, the SAP powder may be used where it is desired to prevent bonding between two cable component surfaces in an optical fiber cable, especially between two polymeric cable components or cable components coated with a polymer and especially where heat is applied or transferred to the cable components.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable, comprising:
a cable jacket;
a plurality of buffer tubes contained within the cable jacket, each of the plurality of buffer tubes having one or more optical fibers disposed therein;
a thin film tube contained within the cable jacket and disposed around the buffer tubes; and
an armor layer contained within the cable jacket and disposed around the thin film tube;
wherein superabsorbent polymer (SAP) powder is disposed between the thin film tube and the armor layer; and
wherein the SAP powder comprises at least 1 wt % of silica particles.

2. The optical fiber cable of claim 1, wherein the SAP powder comprises potassium acrylate acrylamide copolymer.

3. The optical fiber cable of claim 2, wherein the SAP powder comprises particles having average particle sizes in the range of 0 to 230 μm.

4. The optical fiber cable of claim 1, wherein the silica particles comprise fumed silica particles having an average particle size of 100 nm or less.

5. The optical fiber cable of claim 4, wherein the fumed silica particles are hydrophobic.

6. The optical fiber cable of claim 1, wherein the SAP powder comprises from 1 wt % to 5 wt % of the silica particles.

7. The optical fiber cable of claim 1, wherein the armor layer is a laminated armor layer comprising a polymer coating.

8. The optical fiber cable of claim 7, wherein the thin film tube is not bonded to the laminated armor layer along the length of the optical fiber cable.

9. The optical fiber cable of claim 1, wherein the thin film tube comprises an interior surface and an exterior surface and wherein the thin film tube comprises an average thickness of from 0.08 mm to 0.30 mm between the interior surface and the exterior surface.

10. The optical fiber cable of claim 1, wherein the thin film tube comprises at least one of linear low density polyethylene, polypropylene impact copolymer, or a flexible polyvinyl chloride.

11. A method of manufacturing an optical fiber cable, the method comprising the step of:
applying a superabsorbent polymer (SAP) powder between a cable core and an armor layer;
wherein the cable core comprises a plurality of buffer tubes surrounded by a thin film tube, each of the plurality of buffer tubes containing one or more optical fibers;
wherein the SAP powder is applied between an exterior surface of the thin film tube and an interior surface of the armor layer; and
wherein the SAP powder comprises at least 1 wt % of silica particles.

12. The method of claim 11, further comprising the step of extruding the thin film tube around the plurality of buffer tubes prior to the step of applying.

13. The method of claim 12, wherein the thin film tube comprises at least one material selected from the group consisting of linear low density polyethylene, polypropylene impact copolymer, or a flexible polyvinyl chloride.

14. The method of claim 11, wherein the step of applying further comprises running the cable core through a powder applicator having an SAP powder inlet, a pressured gas inlet, and a Venturi region, wherein the method further comprises:
injecting SAP powder through the SAP powder inlet onto the cable core;
injecting pressurized gas into an interior chamber of the powder applicator through the gas inlet; and
circulating the SAP powder passing by the cable core through the Venturi region and back to the cable core.

15. The method of claim 14, further comprising the step of partially forming the armor layer around the cable core prior to the step of applying.

16. The method of claim 15, further comprising the steps of closing the armor layer around the cable core after the step of applying; and
extruding a cable jacket around the closed armor layer.

17. The method of claim 11, further comprising the step of extruding a cable jacket around the armor layer, wherein the step of extruding takes place at a temperature of 180° C. and 230° C. and wherein the SAP powder prevents bonding between the thin film tube and the armor layer.

18. The method of claim 11, wherein the SAP powder comprises potassium acrylate acrylamide copolymer and wherein the SAP powder comprises particles having average particle sizes in the range of 0 to 230 μm.

19. The method of claim 18, wherein the SAP powder comprises from 1 wt % to 5 wt % of a hydrophobic silica flow aid.

20. The method of claim 11, wherein the plurality of buffer tubes are provided around a central strength member and wherein a water-blocking yarn is wrapped around the central strength member.
